(19) United States
(12) Patent Application Publication
(10) Pub. No.: US 2009/0047529 A1
(43) Pub. Date: Feb. 19, 2009

(54) Gas Barrier Film and Method for Producing the Same

(75) Inventors: Mototaka Kawashima, Tokyo (JP); Hiroyuki Oba, Omitama-shi (JP); Juichi Wakabayashi, Chuo-ku (JP)

Correspondence Address: REED SMITH LLP, 3110 FAIRVIEW PARK DRIVE, SUITE 1400, FALLS CHURCH, VA, 22042, US

(73) Assignee: KUREHA CORPORATION, CHUO-KU TOKYO (JP)

(21) Appl. No.: 11/990,269

(22) PCT Filed: Aug. 1, 2006
(86) PCT No.: PCT/JP2006/315197

§ 371 Date: Feb. 11, 2008

(30) Foreign Application Priority Data
Aug. 12, 2005 (JP) 2005-234765

(51) Int. Cl. B32B 15/08

(52) U.S. Cl. 428/458

(57) ABSTRACT

A gas barrier film, comprising a mixture-deposited layer made of a metal and a metal oxide, provided on at least one surface of a polymer film substrate, and characterized in that, where the integration values of the XPS spectrums of the metal and the metal oxide of the above mixture-deposited layer are defined as S_{Me} and S_{MeO}, respectively, the value of the integration value ratio (S_{MeO}/S_{Me}) in the above mixture-deposited layer is 1.5 to 100, and that a resin layer formed using a polycarboxylate-based solution is laminated on at least one surface of the mixture-deposited layer.

### TECHNICAL FIELD

The present invention relates to a gas barrier film and a method for producing the same, and more particularly to a gas barrier film useful as a packaging material or a moisture-proof material for a planar light-emitting device (EL), a vacuum thermal insulating material, an integrated circuit (IC), foods, medicines, and materials for living ware and the like, and to a method for producing the same.

### BACKGROUND OF THE INVENTION

The packaging material for industry, food and other sectors has so far required having a function of preventing the content from deteriorating in quality. In particular, a packaging dealing with a content that would easily deteriorate in quality, the material is required to have excellent gas barrier properties such as water vapor gas barrier properties, as well as properties allowing the content to be recognized, i.e. visibility of the contents.

Accordingly, Japanese Unexamined Patent Application Publication No. Hei 8-142255 discloses a moisture-proof composite film having water resistance formed with the following method. First, a dried membrane is formed on a vapor deposited film made of an inorganic-vapor deposited film, by applying thereon a solution of a mixture which contains, at a predetermined ratio, polyvinyl alcohol, and polycarboxylate or a partially neutralized material thereof. Thereafter, the resultant vapor deposited film is subjected to the heat-treatment at 100° C. or more to obtain the water resistance.

In addition, Japanese Unexamined Patent Application Publication No. Hei 8-142256 discloses a moisture-proof composite film having water resistance formed with the following method. First, a dried membrane is formed on a vapor deposited film made of an inorganic-vapor deposited film by applying thereon a solution of a mixture containing, at a predetermined ratio, polycarboxylate or a partially neutralized material thereof, and sugars. Thereafter, the resultant vapor deposited film is subjected to the heat-treatment at 100° C. or more to obtain the water resistance.

However, the conventional moisture proof composite films described in the above patent documents do not always have sufficient moisture proofness, or sufficient properties allowing the content to be recognized, i.e. visibility.

### DISCLOSURE OF THE INVENTION

In light of the problems that the above prior art has, the present invention is intended to provide a gas barrier film having sufficiently excellent visibility (properties allowing the content to be recognized) as well as advanced moisture proofness, and to provide a method for producing the same.

As a result of intensive studies for accomplishing the above object, the present inventors discovered a way of obtaining a gas barrier film with excellent gas barrier properties, and thereby reaches the completion of the present invention. Specifically, this gas barrier film includes a mixture-deposited layer on at least one surface of a polymer film substrate, and the mixture-deposited layer is made of a metal and a metal oxide mixed at a particular ratio. The excellent gas barrier is provided to the gas barrier film by laminating a resin layer formed using a polycarboxylate-based solution, on at least one surface of the mixture-deposited layer.

The gas barrier film of the present invention is provided with a mixture-deposited layer made of a metal and a metal oxide on at least one surface of a polymer film substrate. When the integration values of XPS spectrums of the metal and the metal oxide of the above mixture-deposited layer are defined as S_{Me} and S_{MeO}, respectively, the value of the integration value ratio (S_{MeO}/S_{Me}) in the above mixture-deposited layer is 1.5 to 100. Moreover, a resin layer formed using a polycarboxylate-based solution is laminated on at least one surface of the above mixture-deposited layer.

In the gas barrier film of the present invention, the metal and metal oxide of the above mixture-deposited layer are preferably aluminum, and aluminum oxide, respectively.

Furthermore, in the gas barrier film of the present invention, the water vapor permeability is preferably 0.10 g/m²·day or less at a temperature of 40° C. and at a relative humidity of 90%.

In addition, as for the gas barrier film of the present invention, the gas barrier film is preferably obtained: by forming a mixture-deposited layer of a metal and a metal oxide on at least one surface of the polymer film substrate with a deposition method; by thereafter applying a polycarboxylate-based solution on the surface of the mixture-deposited layer; and by subsequently drying the solution at a temperature of 50° C. or more to further oxidize the mixture-deposited layer.

A gas barrier film producing method of the present invention is the one for obtaining the gas barrier film: by forming a mixture-deposited layer of a metal and a metal oxide on at least one surface of a polymer film substrate with a deposition method; by thereafter applying a polycarboxylate-based solution on the surface of the mixture-deposited layer; and by subsequently drying the solution at a temperature of 50° C. or more.

In the gas barrier film producing method of the present invention, a gas barrier film having a water vapor permeability of 0.10 g/m²·day or less at a temperature of 40° C. and at a relative humidity of 90% is preferably formed by drying the polycarboxylate-based solution.

The XPS (X-ray photoelectron spectroscopy) allows the atomic binding state of the sample to be known from the energy of photoelectron, the photoelectron is detected from the surface of the sample by irradiating soft X-ray. In addition, the XPS can analyze the surface of the sample from which the contaminant on the uppermost surface is removed by sputtering using rare gas ions such as Ar ion and the like in a depth direction down to the order of submicrons. The XPS spectrum of the present invention is a spectrum obtained with the analysis and measuring method (hereinafter referred to as depth profile measurement). In this method, the depth profile in each chemical state is obtained by sequentially analyzing the surface composition while exposing the interior of the sample, using XPS measurement in combination with rare gas ion sputtering such as Ar, and by combining the separation of a chemical bonding state, using waveform analysis with the obtained analysis result. The XPS spectrum of the present invention is also represented by a vertical axis indicating the concentration (%) in each chemical state (a metal state and a metal oxide state), and by a horizontal axis indicating a sputtering time (approximately correlates with the thickness). The integration value of the XPS spectrum of the metal of the mixture-deposited layer of the present invention is defined as S_{Me}. The integration value of the XPS spectrum of the metal oxide of the mixture-deposited layer of the present invention is defined as S_{MeO}. These values are the respective integration value determined from the XPS spectrums of the metal and metal oxide in the mixture-deposited layer. The value of the integration value ratio (S_{MeO}/S_{Me}) of the metal and metal oxide of the mixture-deposited layer determined from these integration values is the one representing the abundance ratio between the metal and the metal oxide in the mixture-deposited layer.

The present invention makes it possible to provide a gas barrier film having sufficiently excellent visibility and advanced moisture proofness, and to provide a method for producing the same.

### DETAILED DESCRIPTION OF THE PREFERRED EMBODIMENTS

The present invention will be described below in detail with regard to preferred embodiments.

First, the gas barrier film producing method of the present invention will be described. More precisely, this is a method of obtaining the gas barrier film described below: by forming a mixture-deposited layer made of a metal and a metal oxide described below on at least one surface of the polymer film substrate described below with a deposition method; by then applying a polycarboxylate-based solution described below on the surface of the mixture-deposited layer described below; and by subsequently drying the solution at a temperature of 50° C. or more (heat treatment).

The polymer film substrate related to the present invention is only necessary to be the film which does not block the visibility and the moisture proofness and can include a film formed of a polymer material including polyamide such as nylon 6, nylon 66, nylon 12, nylon 6·66 copolymer, nylon 6·12 copolymer; and polyethylene terephthalate (PET), polyethylene naphthalate (PEN), polybutylene terephthalate (PBT), polycarbonate, poly-4-methypenten-1, polyphenylene sulphide, polypropylene (PP), polyimide (PI), polyacrylonitrile (PAN), polylactic acid (PLA), and the like. The material is not particularly limited to the described above. Among these films, A PET film is particularly preferable from the viewpoint of excellent heat resistance, and low influence of humidity. These films are allowed to be an unoriented film or an oriented film, and also in a sheet form.

Although these polymer film substrates may contain various kinds of additives so as to have surface smoothness and surface stability, the amount of additives is preferably as small as possible because adhesion properties between the substrate and the deposited film is reduced if the additives are bled during vacuum deposition. In addition, the thickness of these polymer film substrates is usually 5 to 1000 μm and preferably 10 to 100 μm, not particularly limited, from the viewpoint of softness and economic efficiency.

A metal used as the deposition source of a mixture-deposited layer of a metal and a metal oxide related to the present invention can be a metal usually used to produce a deposited film, and includes, for example, aluminum (Al), cobalt (Co), nickel (Ni), copper (Cu), zinc (Zn), silver (Ag), and the mixture of these metals. Among these metals, Aluminum is preferable from the viewpoint of visibility and oxidation easiness of the metal on the surface of the deposited layer.

A metal oxide used as the deposition source of a mixture-deposited layer of a metal and a metal oxide related to the present invention can be a metal oxide usually used to produce a deposited film, and includes, for example, aluminum oxide (Al₂O₃), silicon oxide (SiOₓ, x=1 to 2), silicon oxynitride (SiOₓN_{y}, x=0.6 to 0.8, y=0.7 to 0.9). Among these metal oxides, Aluminum oxide is preferable from the viewpoint of the moisture proofness and the formation easiness of the oxide.

The amount ratio (molar ratio) between the metal and the metal oxide in a mixture of a metal and a metal oxide related to the present invention is preferably within a range of 3/2 to 100/1 (metal oxide/metal), and more preferably within a range of 5/1 to 20/1. When the amount ratio (molar ratio) between a metal oxide and a metal is less than the lower limit described above, the moisture proofness of the obtained gas barrier film tends to be insufficient. On the other hand, when the ratio exceeds the above upper limit, the flex resistance of the obtained gas barrier film tends to be reduced.

The polycarboxylate-based solution related to the present invention refers to the solution of the existing polycarboxylate-based polymer or the solution of the partially neutralized material of the existing polycarboxylate-based polymer. Such a polycarboxylate-based polymer is only necessary to be a polymer having at least two carboxyl groups in the molecule and can be, for example, the homopolymer of the monomers of unsaturated carboxylic acid such as acrylate, methacrylate, maleate, itaconate, crotonate, fumarate and the like; the copolymer of two kinds or more of the monomers of unsaturated carboxylate; a mixture of two or more kinds of these homopolymers and/or the copolymers (hereinafter occasionally collectively referred to as “polycarboxylate”); and the copolymer of an unsaturated carboxylate monomer and an ethylene-based monomer (ethylene, styrene and the like), not particularly limited. Among these polycarboxylate-based polymers, the homopolymer of acrylate, the homopolymer of methacrylate, and the copolymer of acrylate and methacrylate are preferable from the viewpoint of the gas barrier properties of the obtained film. The homopolymer of acrylate, and the copolymer of acrylate and methacrylate containing a dominant amount of acrylate are particularly preferable.

The number-average molecular weight of such a polycarboxylate-based polymer is preferably within a range of 2,000 to 10,000,000, and more preferably 5,000 to 1,000,000, and particularly preferably 10,000 to 1,000,000. When the number-average molecular weight of the polycarboxylate-based polymer is less than the lower limit described above, the moisture proofness of the obtained gas barrier film tends to be insufficient. On the contrary, when the molecular weight exceeds the upper limit, the coating properties tend to be deteriorated.

Such a partially neutralized material of the polycarboxylate-based polymer is not particularly limited, but can be, for example, the one obtained by partially neutralizing the carboxylic group of the polycarboxylate-based polymer using an alkali to convert the same to a carboxylate. Such an alkali can be, for example, sodium hydroxide, lithium hydroxide, potassium hydroxide, and ammonia (including ammonia water). The partially neutralized material of the polycarboxylate-based polymer can have a desired degree of neutralization by controlling the amount ratio between polycarboxylate and alkali, and is advantageous in that the gas barrier properties can be improved by neutralization as compared to the use of unneutralized carboxylate. The degree of neutralization is preferably more than 0% and not more than 20%, and more preferably more than 0% and not more than 18%, and particularly preferably within a range of 5% to 15%. When the degree of neutralization exceeds the above upper limit, the moisture proofness of the obtained gas barrier film tends to be insufficient.

Incidentally, the degree of neutralization can be determined using the following calculation equation.

Degree of neutralization=(A/B)×100(%)

where A indicates the number of moles of the neutralized carboxylic groups in 1 g of the partially neutralized polycarboxylate, and B indicates the number of moles of the carboxylic groups in 1 g of the partially unneutralized polycarboxylate.

The polycarboxylate-base solution related to the present invention may be the one containing polyalcohol in addition to the polycarboxylate-base polymer or the partially neutralized material of the polycarboxylate based polymer. Such a polyalcohol may be a compound containing two or more of hydroxyl groups in the molecule, and includes, for example, sugars, starches, polyvinyl alcohol (PVA), and the mixture of these materials, not particularly limited. Such sugars include monomeric sugars, oligosaccharides, and polysaccharides, as well as sugar alcohol, and various kinds of substitution products and derivatives. Such starches include the saccharized material of reduced starch. The saponification degree of such polyvinyl alcohol (PVA) is preferably 95% or more, more preferably 98% or more. The polymerization degree of such polyvinyl alcohol (PVA) is preferably within a range of 300 to 2500, more preferably 300 to 1500.

The mixing ratio of the polycarboxylate or the partially neutralized material of the polycarboxylate and these polyalcohols is preferably within a range of 99:1 to 20:80 (weight ratio) from the viewpoint of the heat resistance of the obtained film, more preferably 95:5 to 40:60 (weight ratio), and particularly preferably 90:10 to 60:40 (weight ratio). A method for preparing such a mixture includes, for example, a method of dissolving each component, a method of mixing the aqueous solutions of each component, and a method of polymerizing (metha) acrylate monomer in an aqueous solution of polyalcohol, then partially neutralizing the produced polymer as necessary, not particularly limited.

A solvent used in the polycarboxylate-based solution related to the present invention includes, for example, water, and a mixed solvent of, such as, water and alcohol. A small amount of metal salt of an inorganic acid soluble in water (for example, sodium acetate, and sodium benzoate) may be added to in the above solvent from the viewpoint of the acceleration of the reaction between polycarbonate and polyalcohol.

In the gas barrier film producing method related to the present invention, a mixture-deposited layer of the metal and the metal oxide is first formed on at least one surface of the polymer film substrate with a deposition method. Such a deposition method includes a known method such as a vacuum deposition method, a sputtering method, an ion plating method, and a chemical deposition method, not particularly limited.

The thickness of the mixture-deposited layer of a metal and metal oxide related to the present invention is preferably 100 Å to 3000 Å, more preferably 200 Å to 2000 Å, and particularly preferably 200 Å to 1000 Å. When the thickness of the vapor deposited layer is less than the lower limit above described, the moisture proofness of the obtained film tends to be reduced. On the contrary, when the thickness exceeds the above upper limit, a crack tends to be caused in the vapor deposited film, resulting in the reduction in moisture proofness.

In the gas barrier film producing method related to the present invention, the polycarboxylate-based solution is then applied on the surface of the vapor deposited layer of a mixture. A method for applying the polycarboxylate-based solution includes an applying method using an apparatus such as an air knife coater, a kiss roll coater, a metalling bar coater, a gravure roll coater, a reverse roll coater, a dip coater, a die coater and the like, or the combination of these apparatuses, not particularly limited.

The concentration of the solid content in the polycarboxylate-base solution is preferably 1% to 30% by weight, more preferably 5% to 20%. The applied amount of the polycarboxylate-based solution is preferably 0.1 g/m² to 30 g/m² of the weight per 1 m² immediately after applying the polycarboxylate-based solution, more preferably 1 g/m² to 30 g/m², and particularly preferably 3 g/m² to 30 g/m².

In the gas barrier film producing method related to the present invention, the polycarboxylate-based solution is preferably dried at a temperature of 50° C. or more, more preferably within a temperature range of 100° C. to 300° C., and particularly preferably 140° C. to 250° C. (heat treatment) to obtain a gas barrier film. In the present invention, the drying temperature is necessary to be 50° C. or more. When the drying temperature is less than 50° C., it takes more times to dry the polycarboxylate-based solution, and the oxidation rate of the vapor deposited layer is somewhat less than at 50° C. or more.

A method for drying the polycarboxylate-based solution in the present invention can includes a method in which water and the like are dried by blowing hot air or by irradiating infra-red ray using, for example, an arch dryer, a straight bath dryer, a floating dryer, a tower dryer, a drum dryer, and the combination thereof. Specifically, a method in which water and the like are dried in a drying atmosphere such as hot air, a heating furnace and the like is preferable in that a gas barrier film having good visibility and good moisture proofness can be stably produced. Drying conditions in the drying atmosphere such as hot air, a heating furnace and the like are preferably at a temperature range of 140° C. to 250° C., and for a time period of 1 second to 4 hours, more preferably at a temperature range of 180° C. to 250° C., and for a time period of 1 second to 30 minutes, and particularly preferably at a temperature range of 200° C. to 250° C., and for a time period of 10 seconds to 30 minutes.

The above described gas barrier film producing method of the present invention allows the gas barrier film of the present invention described below to be obtained. That is, the gas barrier film of the present invention is provided with a mixture-deposited layer of a metal and a metal oxide on at least one surface of a polymer film substrate. When the integration values of the XPS spectrums related to the metal and the metal oxide of the mixture-deposited layer described below are defined as S_{Me} and S_{MeO}, respectively, the value of the integration value ratio (S_{MeO}/S_{Me}) in the mixture-deposited layer described below is 1.5 to 100. Moreover, a resin layer formed using a polycarboxylate-based solution is laminated on at least one surface of the mixture-deposited layer described below.

In the present invention, when the integration values of the XPS spectrums related to the metal and the metal oxide of the above mixture-deposited layer are defined as S_{Me} and S_{MeO}, respectively, the value of the integration value ratio (S_{MeO}/S_{Me}) in the above mixture-deposited layer is necessary to be 1.5 to 100, preferably 3 to 50, and particularly preferably 5 to 20. When the value of the integration value ratio (S_{MeO}/S_{Me}) in the above mixture-deposited layer is less than 1.5, the moisture proofness of the obtained gas barrier film is insufficient. On the contrary, when the value of the integration value ratio (S_{MeO}/S_{Me}) exceeds 100, the flex resistance of the obtained gas barrier film is reduced.

In the present invention, the resin layer, which is described below, formed using the polycarboxylate-based solution described above is laminated on at least one surface of the mixture-deposited layer. Such a resin layer is preferably the one obtained by drying the polycarboxylate-based solution at a temperature of 50° C. or more. The thickness of such a resin layer is preferably 0.05 μm to 50 μm, more preferably 0.1 μm to 5 μm, and particularly preferably 0.1 μm to 2 μm.

In the gas barrier film of the present invention, the metal and the metal oxide the mixture-deposited layer are preferably aluminum, and aluminum oxide, respectively.

Furthermore, in the gas barrier film of the present invention, the water vapor permeability is preferably 1 g/m²·day or less at a temperature of 40° C. and at a relative humidity of 90%, more preferably 0.10 g/m²·day or less, and particularly preferably 0.05 g/m²·day or less.

In addition, as for the gas barrier film of the present invention, the gas barrier film is preferably obtained: by forming a mixture-deposited layer of a metal and a metal oxide on at least one surface of the polymer film substrate with a deposition method; by thereafter applying a polycarboxylate-based solution on the surface of the mixture-deposited layer; and by subsequently drying the solution at a temperature of 50° C. or more to further oxidize the mixture-deposited layer.

The gas barrier film of the present invention may be provided with a layer containing a polyvalent metal compound described below, a seal layer, and protective layer in addition to the polymer film substrate, the mixture-deposited layer, and the resin layer which are described above.

The gas barrier film of the present invention may be provided with a layer containing a polyvalent metal compound as a layer abutting to the resin layer to improve the gas barrier properties. Such a polyvalent metal compound includes the elemental substance of a polyvalent metal having a metal ion valence of 2 or more, and the compound thereof. Such a polyvalent metal can include, for example, alkali earth metal such as beryllium, magnesium, calcium and the like; a transition metal such as titan, zirconium, chromium, manganese, iron, cobalt, nickel, copper, zinc and the like; and aluminum. Such a polyvalent metal compound can include, for example, the oxide, hydroxide, carbonate, organic acid salt, inorganic acid salt of the above polyvalent metal, ammonium complexes of the other polyvalent metal, the secondary to quaternary amine complexes of polyvalent metal, and the carbonate and organic acid salt of these complexes. Such an organic acid salt includes acetate, oxalate, citrate, lactate, phosphate, phosphite, hypophosphite, stearate, monoethylene unsaturated carboxylate, and the like. Such an inorganic acid salt can include chloride, sulfate, nitrate, and the like. The other polyvalent metal compound can include alkyl alkoxide of a polyvalent metal.

The gas barrier film of the present invention may be provided with a seal layer to have heat seal properties. A resin used in such a seal layer includes, for example, polyethylene resin such as low density polyethylene (LDPE), linear low density polyethylene (LLDPE), high density polyethylene (HDPE), and ethylene-vinyl acetate copolymer (EVA); and polyacrylonitrile (PAN). Among these, LLDPE, LDPE, and HDPE are preferably used from the viewpoint of heat seal strength. The thickness of such a seal layer is preferably 10 μm to 100 μm, more preferably 10 μm to 90 μm, particularly preferably 10 μm to 70 μm, not particularly limited.

Furthermore, the gas barrier film of the present invention may be provided with a protective layer on the outer surface on the other side of the seal layer to improve the strength of the film. A resin used in such a protective layer can include, for example, polyamide such as nylon 6, nylon 66, nylon 6/66 copolymer, nylon 6/12 copolymer, polyethylene terephthalate (PET), polyethylene naphthalate (PEN), polybutylene terephthalate (PBT), polycarbonate, poly-4-methylpentene-1, polyphenylene sulfide, polypropylene, polyimide, and polyacrylonitrile (PAN). The thickness of such a protective layer is preferably 5 μm to 500 μm, more preferably 10 μm to 100 μm, and particularly preferably 1 μm to 30 μm, not particularly limited.

### EXAMPLE

The present invention will be specifically described below based on examples and comparative examples, but is not limited to the examples. An integration value ratio (S_{MeO}/S_{Me}) of the metal and metal oxide of the mixture-deposited layer (vapor deposited layer), the oxygen permeability, water vapor permeability, and visibility of the gas barrier film were measured and evaluated with each of the following methods.

### (i) Integration Value Ratio (S_{MeO}/S_{Me}) of the Metal and Metal Oxide of the Mixture-Deposited Layer (Vapor Deposited Layer)

Depth profile measurement was carried out using an apparatus for depth profile measurement (5400MC: available from Physical Electronics, Inc.) under conditions that an X-ray source is MgKα, a detection depth is 4 to 5 nm, and a sputtering rate is about 2.5 nm/min (SiO₂ conversion) to obtain an XPS spectrum. Subsequently, the integration values (S_{Me}, S_{MeO}) of the XPS spectrum of the metal and metal oxide of the mixture-deposited layer were determined from the obtained XPS spectrum. Then, the integration value ratio (S_{MeO}/S_{Me}) of the metal and metal oxide of the mixture-deposited layer was determined from the obtained values.

### (ii) Oxygen Permeability of the Gas Barrier Film

Conforming to the method described in ASTM D 3985, the oxygen permeability of the gas barrier film was measured using an oxygen permeation instrument (™OX-TRAN 2/20: available from MOCON, Inc.) under conditions including a temperature of 30° C., a sample area of 50 cm², and a relative humidity (RH) of 80% on both sides.

(iii) Water Vapor Permeability of the Gas Barrier Film

Conforming to the method described in JIS Z-0208, the water vapor permeability of the gas barrier film was measured using a water vapor permeability measuring apparatus (™PERMATRAN-W 3/31: available from MOCON, Inc.) under conditions including a temperature of 40° C., a sample area of 50 cm², relative humidity (RH) of 90% on one side, and relative humidity (RH) of 0% on the other side.

### (iv) Visibility of the Gas Barrier Film

Conforming to the method described in JIS K 7361, the all light beam permeability of the gas barrier film was measured using a turbidimeter (NDH2000: available from Nippon Denshoku Industries Co., Ltd.) under conditions including a temperature of 23° C. and relative humidity of 50%. It was determined that visibility was available (A) when the all light beam permeability of the gas barrier film was 35% or more, and not available (C) when less than 35%.

### Example 1

A calculated amount of sodium hydroxide (available from Wako Pure Chemical Industries, Ltd.) was first added to a 25% by weight aqueous solution of polyacrylic acid (PAA) (available from TOAGOSEI CO. LTD.) having a viscosity of 8000 to 12000 mPa·s at 30° C. and a number average molecular weight of 150000 so as to obtain an aqueous solution of a PAA partially neutralized material having a neutralization degree of 5%.

Sodium hypophosphite (available from Wako Pure Chemical Industries, Ltd.) was then added to the obtained aqueous solution in an equivalent amount of 2% of the weight of a polyacrylic acid solid content. Thereafter, the solid content concentration was adjusted to 10% by weight. Subsequently, an aqueous solution 1 of a PAA partially neutralized material having a solid content concentration of 10% by weight which contains a mixture of a PAA partially neutralized material and the saccharized material of reduced starch with a weight ratio of 80:20 on a solid content basis was prepared by adding the saccharized material of reduced starch after changing the solid content concentration of the reduced starch from 70% by weight to 10%.

Then, the surface of the mixture-deposited layer of a mixture-deposited PET 1 (1015MT: available from TORAY ADVANCED FILM Co. LTD.), which is formed by depositing the mixture of aluminum and aluminum oxide in a thickness of 50 nm (500 Å) on a polyethylene terephthalate (PET) film having a thickness of 12 μm, was coated with the aqueous solution 1 of the PAA partially neutralized material with a Mayer Bar (12 g/m² of the weight per 1 m² immediately after applying the aqueous solution 1 of the PAA partially neutralized material) using a table coater (K303 Proofer: available from RK Print-Coat Instrument Corporation). This mixture-deposited film was dried in a gear oven at a temperature of 200° C. for 15 minutes (heat-treated) to obtain a gas barrier film on which a resin layer 1 having a thickness of 1 μm was formed.

### Example 2

A gas barrier film was obtained in the same manner as that of Example 1 except that a mixture-deposited PET 2 (1015HT: available from TORAY ADVANCED FILM Co. LTD.) was used in place of the mixture-deposited PET 1 as a mixture-deposited PET.

### Example 3

A polyethylene (PE) film (TUX-HC: available from TOHCELLO CO., LTD) having a thickness of 50 μm was laminated on the resin layer 1 of the gas barrier film obtained in Example 1 to obtain a gas barrier film, laminating a urethane-base adhesive layer (main agent: TM-250HV, hardener: CAT-RT86L-60: available from Toyo-Morton Ltd.) having a thickness of 2 μm inbetween.

### Example 4

A nylon (Ny) film (BONYL-RX: available from KOHJIN Co., Ltd.) having a thickness of 25 μm was laminated on the PET film surface of the gas barrier film obtained in Example 3 on which aluminum and aluminum oxide were not deposited to obtain a gas barrier film, laminating a urethane-base adhesive layer (main agent: TM-250HV, hardener: CAT-RT86L-60: available from Toyo-Morton Ltd.) having a thickness of 2 μm in between.

### Example 5

The PAA used in Example 1 was partially neutralized by using a calculated amount of sodium hydroxide (sodium hypophosphite was not added) so as to have a neutralization degree of 5%. Thereafter, the solid content concentration was controlled to prepare an aqueous solution 2 of the PAA partially neutralized material (having a solid content concentration of 10% by weight).

Then, the surface of the mixture-deposited layer of the mixture-deposited PET 1 (1015MT: available from TORAY ADVANCED FILM Co. LTD.) was coated with the aqueous solution 2 of the PAA partially neutralized material with a Mayer Bar (12 g/m² of the weight per 1 m² immediately after applying the aqueous solution 2 of the PAA partially neutralized material) using a table coater. The solution was subsequently dried at a temperature of 80° C. for 10 seconds to form a resin layer 2.

A gas barrier film was obtained by coating the resin layer 2 with a mixture (3 g of zinc oxide particles to 2 g of a polyester-based resin) of zinc oxide particle (available from Wako Pure Chemical Industries, Ltd.) and a polyester-based resin to form a layer containing zinc oxide.

### Example 6

A gas barrier film was obtained in the same manner as that of Example 5 except that magnesium oxide particles were used in place of the zinc oxide particles.

### Example 7

A polyethylene (PE) film (TUX-HC: available from TOHCELLO CO., LTD) having a thickness of 50 μm was laminated on the zinc oxide containing layer of the gas barrier film obtained in Example 5 to obtain a gas barrier film, laminating a urethane-base adhesive layer (main agent: TM-250HV, hardener: CAT-RT86L-60: available from Toyo-Morton Ltd.) having a thickness of 2 μm inbetween.

### Example 8

A polyethylene (PE) film (TUX-HC: available from TOHCELLO CO., LTD) having a thickness of 50 μm was laminated on the magnesium oxide containing layer of the gas barrier film obtained in Example 6 to obtain a gas barrier film, laminating a urethane-base adhesive layer (main agent: TM-250HV, hardener: CAT-RT86L-60: available from Toyo-Morton Ltd.) having a thickness of 2 μm inbetween.

### Comparative Example 1

An aluminum-vapor deposited PET film (VM-PET1510: available from TORAY ADVANCED FILM Co. LTD.), which is produced by forming aluminum-vapor deposited layer having a thickness of 50 nm (500 Å) on a polyethylene terephthalate (PET) film having a thickness of 12 μm, was used.

### Comparative Example 2

A SiOₓ-vapor deposited PET film (MOS-TH: available from Oike & Co., Ltd.), which is produced by forming SiOₓ-vapor deposited layer having a thickness of 80 nm (800 Å) on a polyethylene terephthalate (PET) film having a thickness of 12 μm, was used.

### Comparative Example 3

An Al₂O₃-vapor deposited PET film (1011HG: available from TORAY ADVANCED FILM Co. LTD.), which is produced by forming Al₂O₃-vapor deposited layer having a thickness of 25 nm (250 Å) on a polyethylene terephthalate (PET) film having a thickness of 12 μm, was used.

### Comparative Example 4

A mixture-deposited PET 1 (1015MT: available from TORAY ADVANCED FILM Co. LTD.), which is produced by vapor-depositing a mixture of aluminum and aluminum oxide in a thickness of 50 nm (500 Å) on a polyethylene terephthalate (PET) film having a thickness of 12 μm, was used.

### Comparative Example 5

A gas barrier film was obtained in the same manner as that of Example 1 except that an aluminum-vapor deposited PET film (VM-PET1510: available from TORAY ADVANCED FILM Co. LTD.) was used as a vapor deposited PET in place of the mixture-deposited PET 1.

### Comparative Example 6

A gas barrier film was obtained in the same manner as that of Example 1 except that the SiOₓ-vapor deposited PET film (MOS-TH: available from Oike & Co., Ltd.) was used as a vapor deposited PET in place of the mixture-deposited PET 1.

### Comparative Example 7

A gas barrier film was obtained in the same manner as that of Example 1 except that the Al₂O₃-vapor deposited PET film (1011HG: available from TORAY ADVANCED FILM Co. LTD.) was used as a vapor deposited PET in place of the mixture-deposited PET 1.

<Evaluation Result>

The integration value ratio (S_{MeO}/S_{Me}) of the metal and metal oxide of the mixture-deposited layer (vapor deposited layer), oxygen permeability, water vapor permeability, and visibility of the gas barrier film obtained in Examples 1 to 8, and in Comparative Examples 1 to 7 are as shown in Table 1.

TABLE 1

| | | Integration value ratio | | | |
|---|---|---|---|---|---|
| | | of the metal and metal | Oxygen | | |
| | | oxide of the | permeability | Water vapor | |
| | | mixture-deposited | (cm³/m² · day · | permeability | |
| | Layer construction | layer (S_{MeO}/S_{Me}) | atm) | (g/m² · day) | Visibility |
| Example 1 | PET/AL, Al₂O₃ mixture-deposited | 14 | <0.01 | 0.05 | A |
| | 1/resin layer 1 | | | | |
| Example 2 | PET/AL, Al₂O₃ mixture-deposited | 8 | <0.01 | 0.05 | A |
| | 2/resin layer 1 | | | | |
| Example 3 | PET/AL, Al₂O₃ mixture-deposited | 14 | <0.01 | 0.05 | A |
| | 1/resin layer 1/PE | | | | |
| Example 4 | Ny/PET/AL, Al₂O₃ | 14 | <0.01 | 0.05 | A |
| | mixture-deposited 1/resin | | | | |
| | layer 1/PE | | | | |
| Example 5 | PET/AL, Al₂O₃ mixture-deposited | 14 | <0.01 | 0.05 | A |
| | 1/resin layer 2/ZnO | | | | |
| Example 6 | PET/AL, Al₂O₃ mixture-deposited | 14 | <0.01 | 0.05 | A |
| | 1/resin layer 2/MgO | | | | |
| Example 7 | PET/AL, Al₂O₃ mixture-deposited | 14 | <0.01 | 0.05 | A |
| | 1/resin layer 2/ZnO/PE | | | | |
| Example 8 | PET/AL, Al₂O₃ mixture-deposited | 14 | <0.01 | 0.05 | A |
| | 1/resin layer 2/MgO/PE | | | | |
| Comparative | PET/AL vapor deposited | 0.3 | 1.0 | 1.5 | C |
| Example 1 | | | | | |
| Comparative | PET/SiO₂ vapor deposited | 100< | 1.6 | 1.0 | A |
| Example 2 | | | | | |
| Comparative | PET/Al₂O₃ vapor deposited | 100< | 1.5 | 1.0 | A |
| Example 3 | | | | | |
| Comparative | PET/AL, Al₂O₃ mixture-deposited | 12 | 1.4 | 0.6 | A |
| Example 4 | 1 | | | | |
| Comparative | PET/Al vapor deposited/resin | 0.4 | 0.02 | 0.2 | C |
| Example 5 | layer 1 | | | | |
| Comparative | PET/SiO₂ vapor deposited/resin | 100< | 0.02 | 0.2 | A |
| Example 6 | layer 1 | | | | |
| Comparative | PET/Al₂O₃ vapor deposited/resin | 100< | 0.03 | 0.6 | A |
| Example 7 | layer 1 | | | | |

As seen from the result shown in Table 1, it is confirmed that the gas barrier film (Examples 1 to 8) is sufficiently excellent in the water vapor permeability and oxygen permeability, as well as the visibility of the gas barrier film.

### INDUSTRIAL APPLICABILITY

As described above, the present invention makes it possible to provide a gas barrier film having sufficiently excellent visibility as well as advanced moisture proofness.

Therefore, the gas barrier film of the present invention is useful as a packaging material or a moisture-proof material for a planar light-emitting device (EL), a vacuum thermal insulating material, an integrated circuit (IC), foods, medicines, and materials for living and the like.

1. A gas barrier film, comprising a mixture-deposited layer made of a metal and a metal oxide provided on at least one surface of a polymer film substrate,
wherein, where the integration values of the XPS spectrums of the metal and the metal oxide of the above mixture-deposited layer are defined as S_{Me} and S_{MeO}, respectively, the value of the integration value ratio (S_{MeO}/S_{Me}) in the above mixture-deposited layer is 1.5 to 100, and
a resin layer formed using a polycarboxylate-based solution is laminated on at least one surface of the mixture-deposited layer.

2. The gas barrier film according to claim 1,
wherein the metal and metal oxide of the mixture-deposited layer are aluminum, and aluminum oxide, respectively.

3. The gas barrier film according to claim 1,
wherein the water vapor permeability is 0.10 g/m²·day or less at a temperature of 40° C. and at a relative humidity of 90%.

4. The gas barrier film according to claim 1,
wherein the film is obtained by forming a vapor deposited layer of a mixture of a metal and a metal oxide on at least one surface of the polymer film substrate with a vapor deposition method, by then applying a polycarboxylate-base solution on the surface of the mixture-deposited layer, and by subsequently drying the solution at a temperature of 50° C. or more to further oxidize the mixture-deposited layer.

5. A gas barrier film producing method for obtaining the gas barrier film according to claim 1, the method comprising:
forming a vapor deposited layer made of a mixture of a metal and a metal oxide on at least one surface of the polymer film substrate by a vapor deposition method;
applying a polycarboxylate-based solution on the surface of the mixture-deposited layer; and
subsequently drying the solution at a temperature of 50° C. or more.

6. The gas barrier film producing method according to claim 5,
wherein a gas barrier film having a water vapor permeability of 0.10 g/m²·day or less at a temperature of 40° C. and at a relative humidity of 90% is formed by drying the polycarboxylate-based solution.
